(19) United States
(12) Patent Application Publication
(10) Pub. No.: US 2003/0050970 A1
(43) Pub. Date: Mar. 13, 2003

(54) Information evaluation system, terminal and program for information inappropriate for viewing

(75) Inventor: Noboru Akiyama, Nagoya (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/062,659

(22) Filed: Feb. 5, 2002

(30) Foreign Application Priority Data
Sep. 13, 2001 (JP) 2001-278242

(51) Int. Cl. G06F 15/16; G06F 17/00

(52) U.S. Cl. 709/203; 707/104.1

(57) ABSTRACT

An information evaluation system evaluating information to be viewed on a network is disclosed, the system being provided with receiving unit receiving a report on information which is inappropriate for viewing; evaluating unit evaluating an inappropriateness level of the information based on the report; and distributing unit distributing information regarding locations on a network of such inappropriate information having the inappropriateness level in a predetermined range.

### BACKGROUND OF THE INVENTION

Due to the development of information communications technology, it has become possible to obtain various kinds of information easily through networks such as the Internet. Further, in the case of the Internet, a user can establish a web site and distribute information easily.

However, on the other hand, much harmful information is distributed over the Internet, and many web sites containing harmful information have been established. Here, the harmful information refers to a content, which includes pornography or violent scenes, for example.

Methods for eliminating access to and sending of such harmful information have also been proposed. For example, there are services in which searches for information are performed using key words, or in which confirmation is provided through reports and the like, whereby the harmful information is searched, a black list is created/distributed, and a restriction on the access to the site (or a part of the site), which distributes the harmful information, is executed.

However, information on the Internet is frequently changed. Thus, and it was difficult to follow the changes and create and distribute the black list. That is, with this method, the service could not be provided in real time. Further, merely with the key word search, the precision in searching for the harmful information was low.

In addition, regarding the reports notifying the harmful information, there were cases where the criteria by which harmfulness and unharmfulness were judged fluctuated depending on the subjectivity of the reporter. Therefore, there were cases where information, which would not be harmful according to a standard sensibility, was considered to be harmful by a sensitive reporter.

### SUMMARY OF THE INVENTION

The present invention has been made in view of the above-mentioned problems inherent in the conventional technology. In other words, an object of the present invention is to provide, information indicating a location of a site or a portion of a site which sends out harmful information timely.

In addition, another object of the present invention is to provide a function, which is performed in the above-mentioned case on various kinds of information, for restricting access to information, which is inappropriate for viewing by respective individuals, without limiting the harmful information to pornography and violent material.

Furthermore, still another object of the present invention is to improve the generality of the judgement of “harmfulness” and “unharmfulness”.

In order to solve the above-mentioned object, the present invention adopts the following measures. Namely, the present invention provides an information evaluation system (1) for evaluating information to be viewed on a network, the system being provided with:

receiving unit receiving a report of information which is inappropriate for viewing;

evaluating unit evaluating an inappropriateness level of the information based on the report; and

distributing unit distributing information regarding locations on a network of such inappropriate information having the inappropriateness level in a predetermined range.

Information which is inappropriate for viewing is information which is harmful to disclose on a public network, for example. This kind of information evaluation function is realized on a server which is connected to the network, for example.

In this way, the present information evaluation system collects a report from a user, evaluates the report, treats information having a given level as inappropriate information, and distributes the location of the inappropriate information on the network; therefore, the information which is inappropriate for viewing can be detected efficiently and managed unitarily. Distribution of the location information, such as that described above, to the user helps the user restrict access to the inappropriate information in a uniform fashion.

It is preferable that the information evaluation system is further includes classifying unit classifying a reporter who sent the report into a classification; wherein

the evaluating unit evaluates the inappropriateness level of the information in accordance with the classification of the reporter.

Classifying the reporter is done according to attributes of the reporter, such as family structure, occupation or residential area, for example. By altering the evaluation of the report according to such a classification, a more accurate evaluation becomes possible.

It is preferable that the information evaluation system is further includes identifying unit identifying a reporter who sent the report; wherein

the report includes the information regarding the location of the information on the network, and

the evaluating unit excludes a second report and subsequent reports by the same reporter regarding the same location from its evaluation of the inappropriateness level.

In this way, a duplicate report from the same reporter regarding the same information can be excluded from the objects evaluated.

It is preferable that the information evaluation system is further provided with identifying unit identifying a reporter who sent the report; and accumulating unit accumulating information pertaining to contributions per reporter in the evaluation of the inappropriateness level; wherein

the evaluating unit reflects the contributions accumulated per reporter in its evaluation of inappropriateness level of the information.

In this way, reflecting the contributions per reporter enables a more accurate evaluation. Here, the information pertaining to contributions is, for example, a performance value or the like, which quantifies performance based on whether information reported by the reporter was actually determined to be inappropriate information.

It is preferable that the report has a category of the information which is the subject of the report; and

the evaluating unit evaluates the inappropriateness level of the information per the category.

The category of the information which is the subject of the report is a classification of the information which the reporter thinks is inappropriate for viewing, such as pornography and violence, for example.

It is preferable that the information evaluation system further comprises:

identifying unit identifying a reporter who sent the report;

classifying unit classifying the reporter into a classification; and

accumulating unit accumulating the information pertaining to contributions per reporter in the evaluation of the inappropriateness level; wherein

the report has a category of the information which is the subject of the report; and

the evaluating unit reflects a relationship of a combination of 2 or more from among the category, the classification of the reporter and the contributions accumulated per reporter in its evaluation of inappropriateness level.

In this way, the evaluation is made reflecting the relationship of the combination of the category of information, the classification of the reporter and the contributions accumulated per reporter, which produces the result that a more accurate evaluation becomes possible. This is because there are reporters who make enthusiastic efforts in discovering certain information, for example. Also, reporters who contributed in the past have a high chance of contributing in the future.

Further, the present invention also provides a terminal (11) for accessing information on a network, the terminal being provided with:

accessing unit (14) accessing information on a network;

displaying unit (14) displaying the information;

inputting unit (13) inputting a report on the display of information which is inappropriate for viewing;

sending unit sending the report to a predetermined server;

receiving unit receiving, from the server which has totaled up the reports, locations on the network of such inappropriate information having an inappropriateness level in a predetermined range; and

restricting unit restricting access to the inappropriate information.

By using such a terminal, the user can prevent access to disagreeable information.

Further, the present invention provides an information evaluation method executed on a computer which evaluates information to be viewed on a network, the method comprising the steps of:

receiving (S8) a report of information which is inappropriate for viewing;

evaluating (S92-S99) an inappropriateness level of the information based on the report; and

distributing (S103,S113) information regarding locations on a network of such inappropriate information having the inappropriateness level in a predetermined range.

According to such a procedure, the information which is inappropriate for viewing can be detected efficiently and controlled unitarily. The present invention distributes the location information, such as that described above, to the user, which helps the user restrict access to the inappropriate information in a uniform fashion.

The present invention also provides a program for making the computer achieve any of the above functions. Further, the present invention may also provides such a program recorded on a computer-readable recording medium.

### BRIEF DESCRIPTION OF THE DRAWINGS

In the accompanying drawings:

FIG. 1 is a diagram showing an outline of a function for collecting harmful information;

FIG. 2 is a diagram showing an outline of processing for creating a list of harmful information;

FIG. 3 is a diagram showing an outline of a method of distributing the list of harmful information;

FIG. 4 is a diagram showing a data structure of a personal information table;

FIG. 5 is a diagram showing a data structure of a family structure ID table;

FIG. 6 is a diagram showing a data structure of an occupation ID table;

FIG. 7 is a diagram showing a data structure of a residential area ID table;

FIG. 8 is a diagram showing a data structure of a reporter table;

FIG. 9 is a diagram showing a data structure of a user table;

FIG. 10 is a diagram showing a data structure of an information category table;

FIG. 11 is a diagram showing a data structure of a report table;

FIG. 12 is a diagram showing a data structure of a harmful information candidate list table;

FIG. 13 is a diagram showing a data structure of a harmful information list table;

FIG. 14 is a diagram showing a data structure of a table of a degree of reliability by a family structure and by a category;

FIG. 15 is a diagram showing a data structure of a table of a degree of reliability by occupation and by a category;

FIG. 16 is a diagram showing a data structure of a table of a degree of reliability by a residential area and by a category;

FIG. 17 is an example of a screen displayed on a personal computer of the reporter;

FIG. 18 is a flow chart showing a procedure of collecting the harmful information;

FIG. 19 is a flow chart showing a procedure of the processing for creating the harmful information list;

FIG. 20 is a flow chart showing a procedure of distributing to the user the harmful information list and restricting access to a harmful site; and

FIG. 21 is an example of a report screen, according to a variation example of the present information system.

### DETAILED DESCRIPTION OF THE PREFERRED EMBODIMENTS

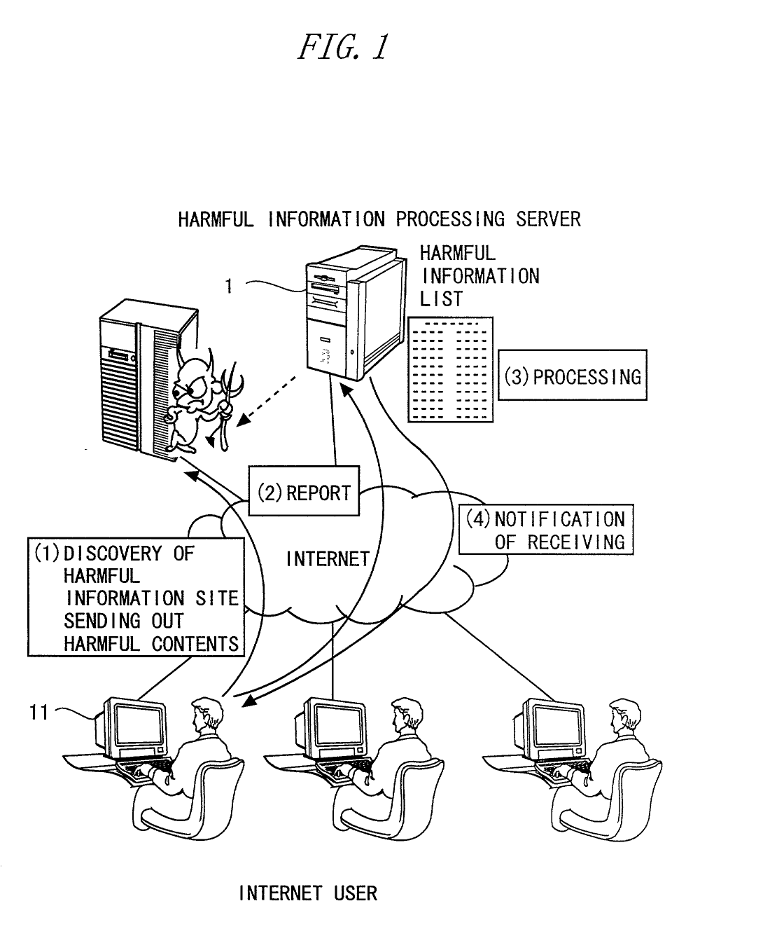

Hereinafter, explanation will be made of an embodiment of the present invention based on the diagrams of FIGS. 1-21.

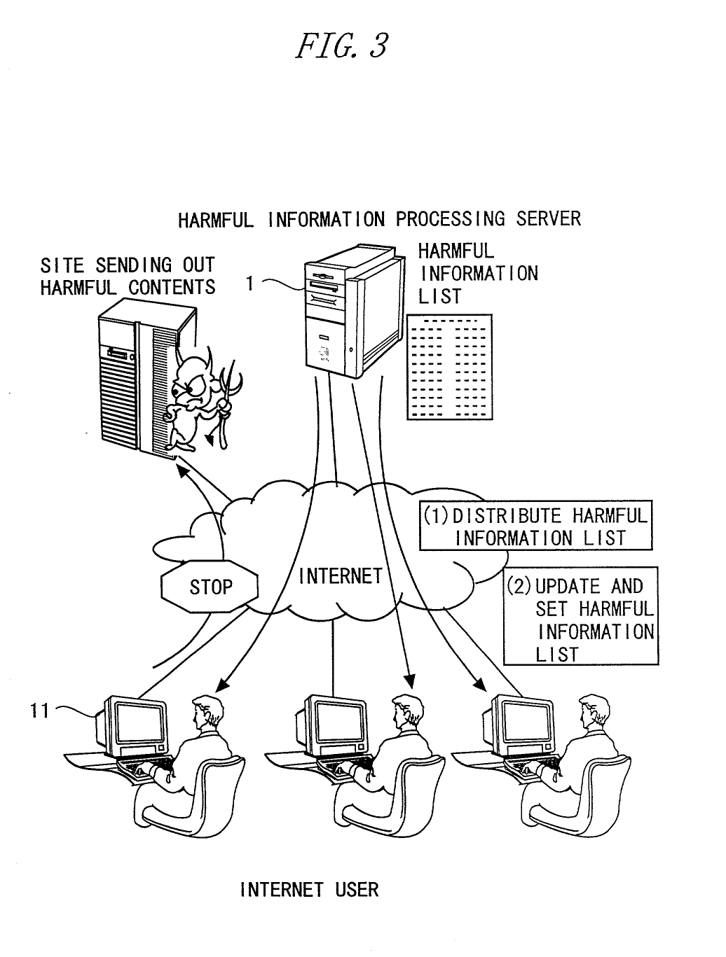

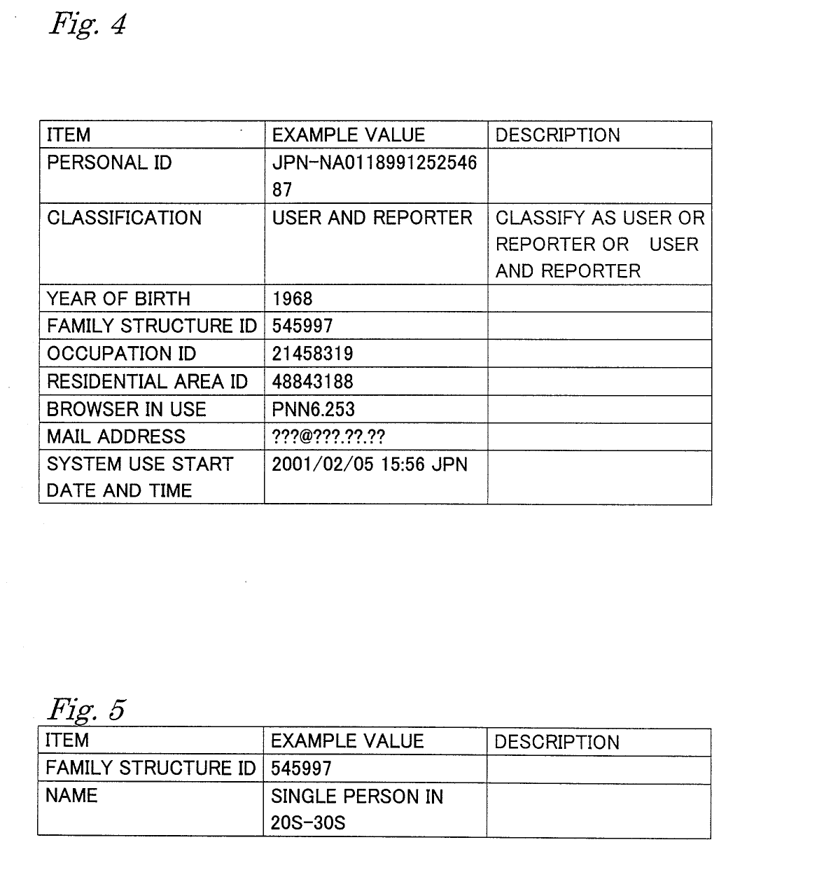

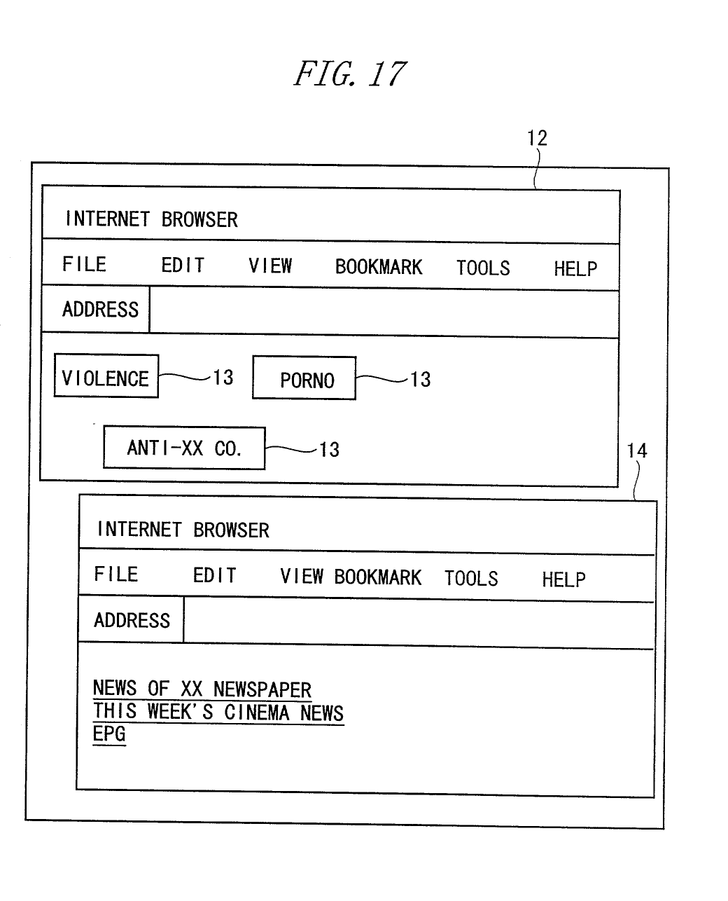

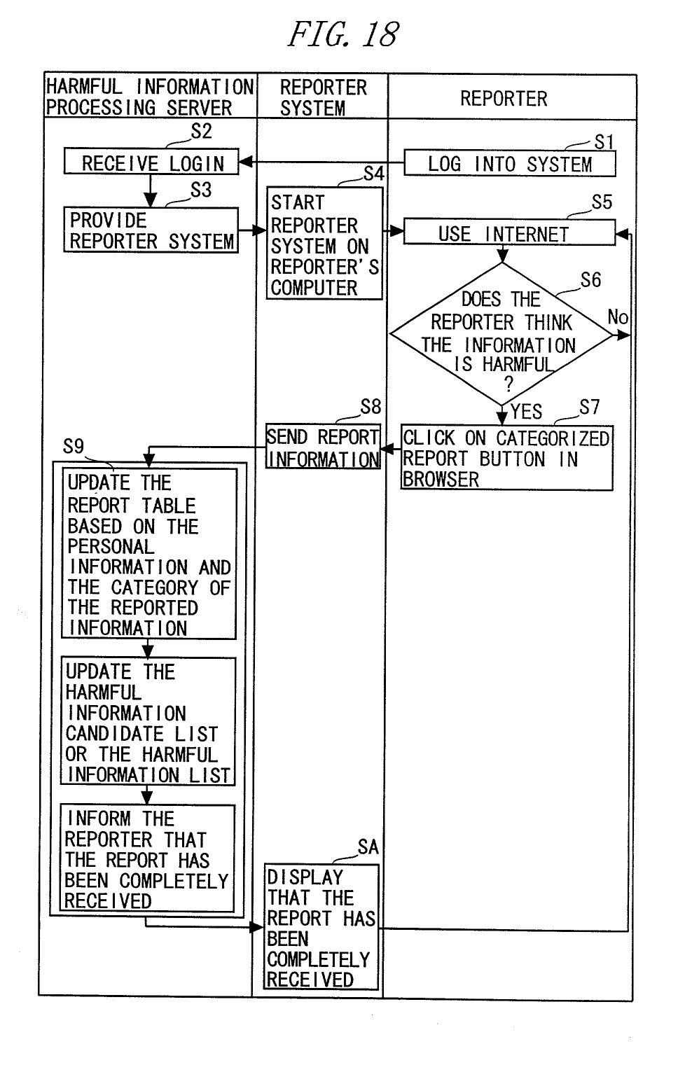

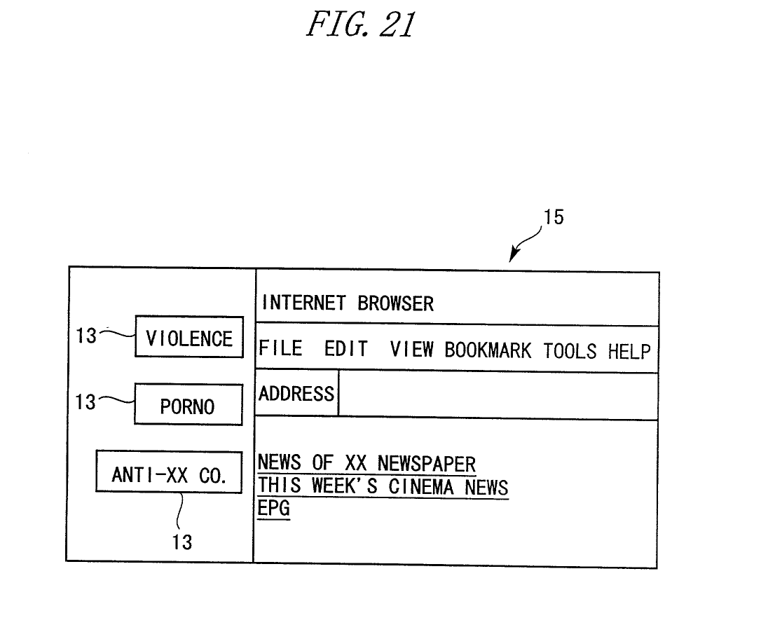

FIGS. 1-3 are diagrams showing outline of functions of an information system according to an embodiment of the present invention; FIGS. 4-16 are diagrams showing data structures of data managed by a harmful information processing server 1 shown in FIG. 1 and FIG. 3; FIG. 17 is a diagram showing a screen of a browser executed on a personal computer 11 shown in FIGS. 1-3; FIGS. 18-20 are flow charts showing processing of the present information system; and FIG. 21 is a diagram showing a screen of a browser according to a variation example of the present invention.

<Outline of the Functions>

Hereinafter, explanation will be made of an outline of functions of the present information system. According to the following procedures, the present information system detects harmful information on the Internet and restricts a user's access to the harmful information.

(1) According to the present information system, recruiting is directed at Internet users to recruit users of the present information system. The recruiting may be performed on an Internet web site, for example.

A user who has registers with the present information system. With this registration, the user registers a category of information which the user wants to make it as harmful information, such as pornography or violent scenes, together with identification information of the user.

The user receives distribution of a harmful information list indicating locations on the network of information in the registered category, and access to such harmful information is restricted. The user can register him/herself as such a normal user, and also can register as a reporter who reports the harmful information. Hereinafter, “user” means not only the normal user, but also includes the user who is the reporter. “Reporter” is used to make reference only to the user who provides the report.

(2) The user first logs in the harmful information processing server 1. Then, the harmful information processing server 1 downloads a user system to the user. The user system is then incorporated into the browser and limits access to the harmful information by the browser. However, the user system may also be a patch file to patch a particular module comprising the browser.

Further, the harmful information processing server 1 downloads a reporter system to the reporter. The reporter system displays a report button for reporting the harmful information on the browser used by the reporter.

(3) When the reporter has discovered a site (or a portion of a site) which sends out harmful information while using the Internet, the reporter clicks on the report button provided on in the browser. Accordingly, the above-mentioned site is reported to the harmful information processing server 1.

(4) The report button provided in the browser is categorized according to the registration information of the reporter into categories such as pornography, violence or the like, and has a label applied to it, which indicates the category. Each report button is used to report the discovery of information belonging to the respective categories.

(5) After the harmful information processing server 1 on the Internet has received the report, it then performs its original processing and judges whether the information is harmful information or not.

(6) The harmful information processing server 1 distributes the harmful information list (black list), which is created for each individual according to the user's registration information, via the Internet to the user's computer.

(7) At the user's computer which has received the harmful information list, when the user accesses a web site on the Internet, the user system determines whether that web site concerned is included in the list or not. Then, the user system prohibits the browser from accessing the web site which is included in the harmful information list.

FIG. 1 shows an outline of a function of collecting the harmful information in the present information system. As shown in FIG. 1, the information system is comprised of a personal computer 11 used by the user, and the harmful information processing server 1 for receiving the report of harmful information from the (other) user and determining a level of harmfulness of the harmful information. The personal computer 11 and the harmful information processing server 1 are both connected to the Internet and access a web server which sends out various kinds of information, such as a harmful content. Construction and operation of such a personal computer 11 and harmful information processing server 1 are widely known; therefore, explanation is omitted here.

When the system user of the present information system (i.e., the reporter) discovers the harmful information (FIG. 1 (1)), he or she presses the report button on the browser. When the pressing of the report button is detected, the browser sends to the harmful information processing server 1 the report indicating the category of the harmful information together with the URL (Uniform resource locator) of the web site currently being accessed (FIG. 1 (2)).

The harmful information processing server 1 accesses the URL which has been reported, and checks the following (FIG. 1 (3)). First, the harmful information processing server 1 confirms whether the web site at that URL exists or not.

Then, in the case where the web site exists, the harmful information processing server 1 performs a key word search on the web site for the type of information for which the report was received, and thus investigates whether matching key words exist in that web site or not. From among the sites reported, the harmful information processing server 1 adds to the harmful information candidate list only the sites which have passed the above test. Additionally, the harmful information processing server 1 notifies the user that the report was received (FIG. 1 (4)).

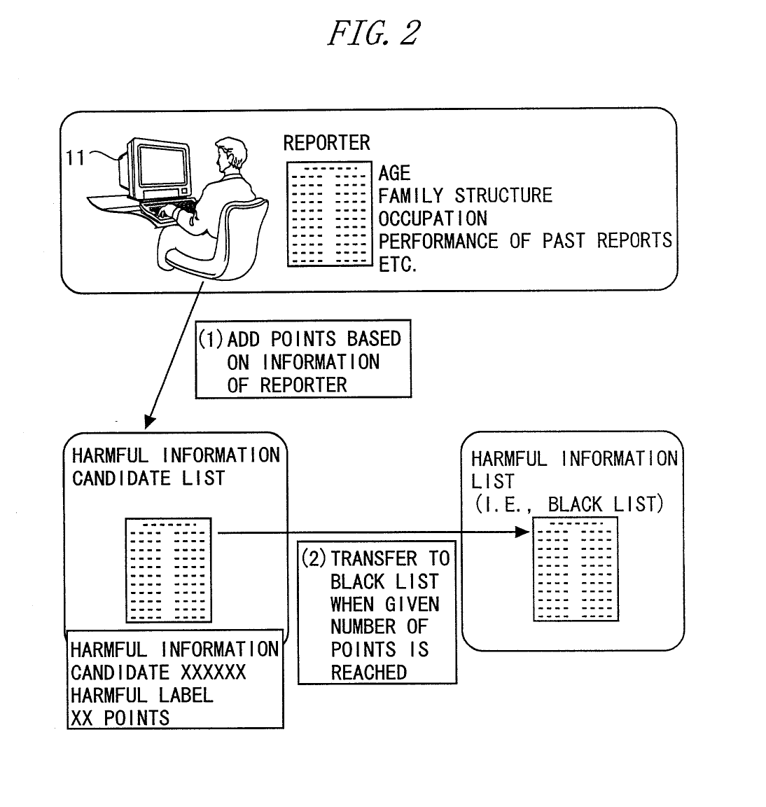

FIG. 2 shows an outline of a processing of creating the harmful information list. In this processing, the harmful information processing server 1 first registers the site (or the portion of the site) for which the report was received in the harmful information candidate list (FIG. 2 (1)). The site which has been registered in the harmful information candidate list is called a harmful information candidate.

At this time, the harmful information processing server 1 adds points, which were calculated by a comprehensive evaluation of the reporter's information, to an entry for the given site in the harmful information candidate list. In the case where there have been multiple reports, the harmful information processing server 1 adds points corresponding each of the reports. The value which is added up in this way is called the harmfulness level.

Next, when the harmfulness level reaches a predetermined number of points (this is called a threshold value), the harmful information processing server 1 moves the harmful information candidate over to the harmful information list (FIG. 2 (2)).

FIG. 3 shows an outline of a method of distributing the harmful information list. The harmful information processing server 1 creates the harmful information list corresponding to the category registered for each user. Then, the harmful information processing server 1 distributes the harmful information list to each user individually periodically via the Internet (FIG. 3 (1)).

When the personal computer 11 has received the harmful information list, it immediately updates the harmful information list. Thereafter, the browser, which has the user system incorporated into it, prohibits access to the site (or the portion of the site) which is contained in the harmful information list.

<Data Structures>

FIGS. 4-16 show data structures of tables kept by the harmful information processing server 1. FIG. 4 shows the data structure of a personal information table. The personal information table is a table for registering personal attributes of the user of the present information system. The personal information table is set from information inputted at the time of application to use the information system. FIG. 4 shows data for one record (i.e., for one set of data) in the table (hereinafter, the situation is the same in FIG. 5 and the like).

As shown in FIG. 4, the personal information table has respective fields for a personal ID, a classification, a year of birth, a family structure ID, an occupation ID, a residential area ID, the browser in use, a mail address and a system use start date and time.

The personal ID is a character string for identifying individual users. The classification is a classification indicating whether the individual is the user, the reporter or the both. The year of birth is the year in which the user was born.

The family structure ID, the occupation ID and the residential area ID are each character strings for identifying family structure, occupation and residential area, respectively. These IDs are each defined in a family structure ID table, an occupation ID table and a residential area ID table, respectively.

The browser in use is information indicating a type and version of the browser being used by the user concerned. The user system incorporated into the user's browser (or patching the user's browser) is created and distributed on the basis of this information.

The mail address is an electronic mail address of the user. The system use start date and time is a date and time when the user first logged into the harmful information processing server 1.

FIG. 5 shows a data structure of the family structure ID table. The table defines a relationship between a value of the family structure ID and a family structure. For example, when a family structure ID is 545997, it is defined that the family structure is comprised of a single person in his or her 20s-30s, for example.

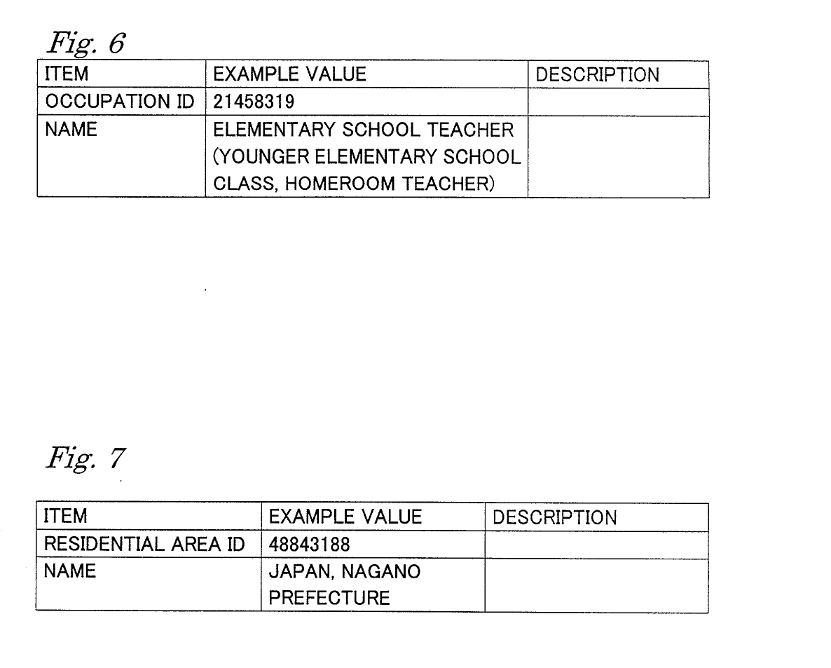

FIG. 6 shows a data structure of the occupation ID table. The table defines a relationship between a value of the occupation ID and an occupation. For example, when the occupation ID is 21458319, it is defined that the occupation is that of an elementary school teacher and a homeroom teacher of a lower grade class, for example.

FIG. 7 shows a data structure of the residential area ID table. The table defines a relationship between a value of the residential area ID and a name of a residential area. For example, when the residential area ID is 48843188, it is defined that the name of the residential area is Nagano Prefecture, Japan, for example.

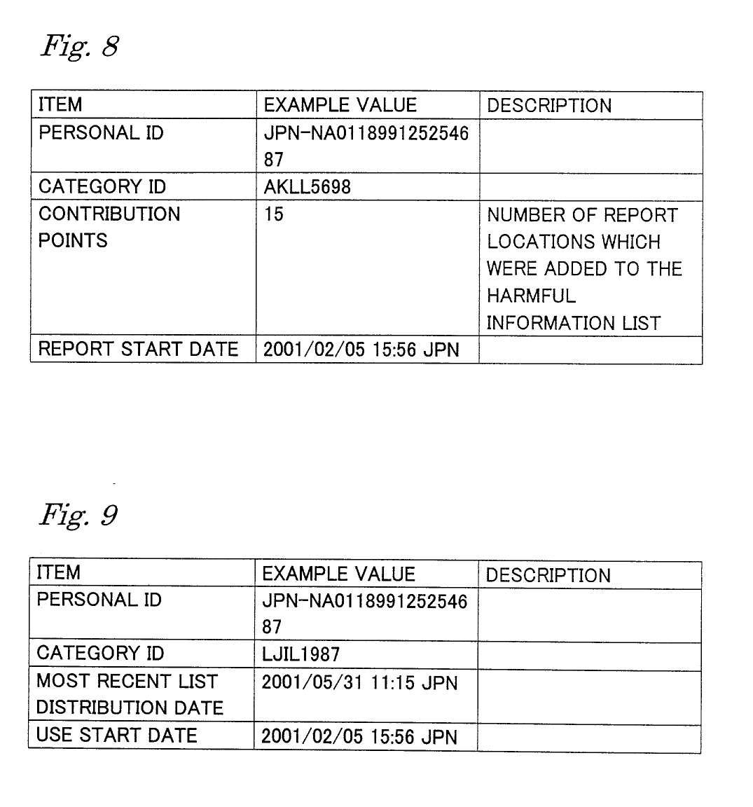

FIG. 8 shows a data structure of a reporter table. As shown in FIG. 8, the reporter table has respective fields for a personal ID, a category ID, contribution points and a report start date. Of those, the personal ID is the ID defined in the personal information table shown in FIG. 4. The personal ID clarifies which user the data concerned in the reporter table pertains to.

The category ID is an ID for indicating the category of the information which the reporter (user) concerned thinks is harmful. The category ID is defined in an information category table.

The contribution points record the number of sites reported by the reporter which were added to the harmful information list. The contribution points record how much the reporter contributed to the creation of the harmful information list. The report start date is the date and time when the reporter first made a report.

FIG. 9 shows a data structure of a user table. As shown in FIG. 9, the user table has respective fields for the personal ID, the category ID, a most recent list-distribution date and a use start date. The personal ID and the category ID are the same as in the reporter table of FIG. 8. Further, the most recent list distribution date is the last date and time when the harmful information list was distributed to the user concerned. Further, the use start date is the date and time when the user first logged into the information system.

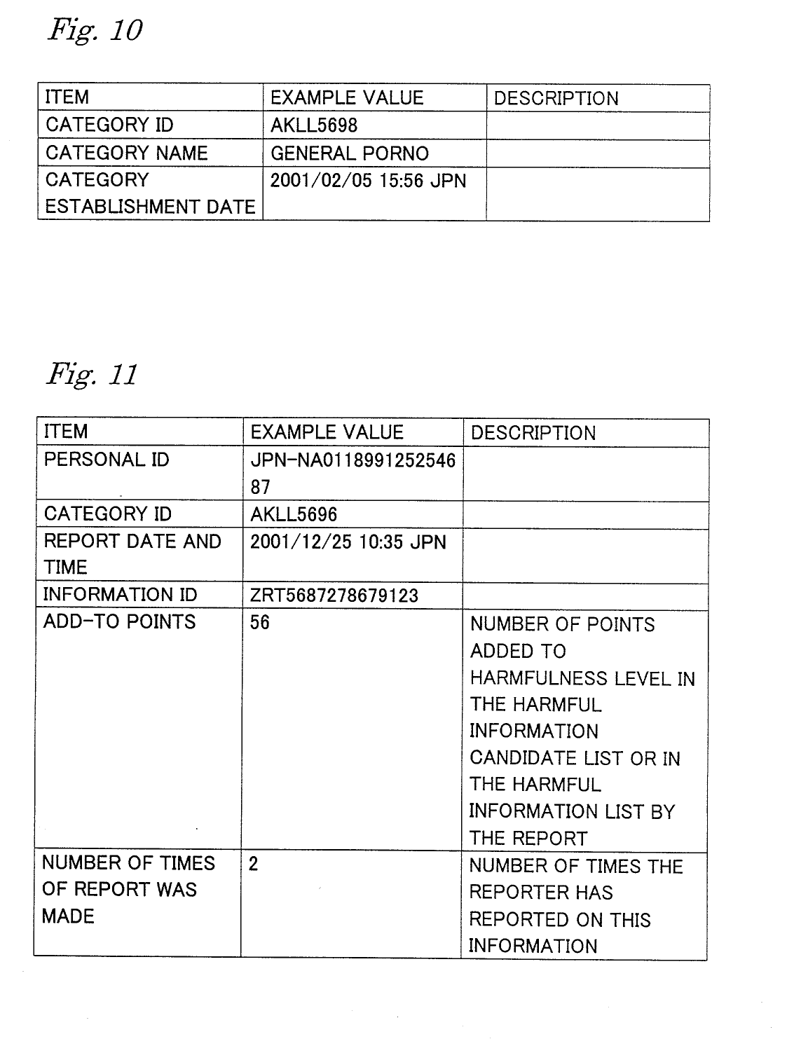

FIG. 10 shows a data structure of the information category table. The information category table is a table defining the type of information that the user thinks is harmful. The information category table has respective fields for the category ID, a category name and a category establishment date.

The category ID is a symbol for identifying individual categories. The category name is a name indicating the type of information. For example, general porn (i.e., pornography-related information in general), violence (i.e., images, text and the like which suggest violence), anti-XXX (i.e., information in general which relates to a particular professional baseball team, for example) and the like define the type of information. The category establishment date is a date on which the category was established.

FIG. 11 shows a data structure of a report table. The report table is a table for recording that there was the report from the reporter. The report table has respective fields for the personal ID, the category ID, a report date and time, an information ID, add-to points and a number of times the report was made.

The personal ID is the individual ID of the reporter. The category ID is the category ID indicating the category of the reported harmful information site. The report date and time is the most recent report date and time. The information ID is a symbol for individually identifying the site or the portion of the site posting the harmful information which is the subject of the report.

The add-to points are points to be added to the harmfulness level of the reported harmful information. The add-to points are determined by statistical processing based on the attributes of the reporter, namely the reporter's year of birth, family structure, occupation, residential area, etc.

For example, a report of pornography from an elementary or junior high school teacher is highly reliable, and will often be given high add-to points. Further, a report of a violence-related site from a reporter who has children will often be given high add-to points. Further, a report from a reporter who has many contribution points (see the reporter table of FIG. 8) will be given many add-to points.

The number of times the report was made is a number of times that the reporter reported the information (i.e., the harmful information site). In the case where the same person has reported the same harmful information, the present harmful information processing server 1 records the number of times the report was made. However, the second and subsequent reports are not added to the harmfulness level.

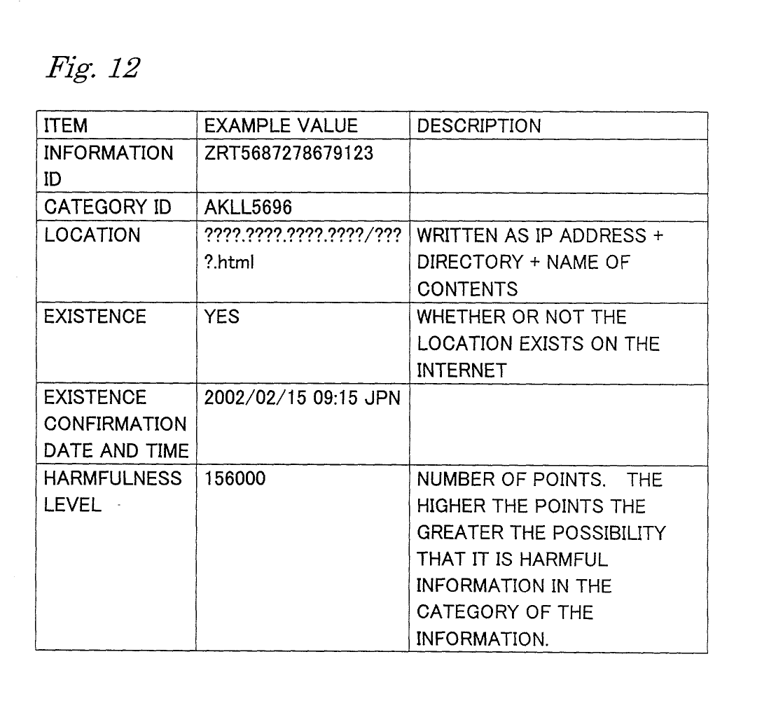

FIG. 12 shows a data structure of a harmful information candidate list table. From among the reported harmful information, the table registers that harmful information of which the harmfulness level does not attain the predetermined threshold value. The harmful information candidate list table has respective fields for the information ID, the category ID, a location, existence, an existence confirmation date and time, and the harmfulness level.

The information ID is a symbol for individually identifying each reported harmful information, as explained regarding the report table of FIG. 11. The category ID is an ID for indicating the category of the harmful information.

The location is a network location of the web site which sends out the harmful information. The location is indicated by, for example, an IP address+a directory in a computer indicated by the IP address+a name of the contents. However, instead of the IP address a domain name may be used.

In the existence field it is registered whether the harmful information exists or not. Existence or non-existence is determined at the time when a report has been received by whether it is actually possible for the harmful information processing server 1 to access the harmful information and achieve access or not. The existence confirmation date and time is the date and time when the existence confirmation was performed.

The harmfulness level is a cumulative value of the add-to points reported by the multiple reporters for the harmful information in question (see the report table of FIG. 11). As has already been discussed, the harmfulness level is added only once for the same reporter. This is to prevent the harmfulness level from being increased arbitrary by individuals, or on a basis of bias or the like on the part of a specific individual.

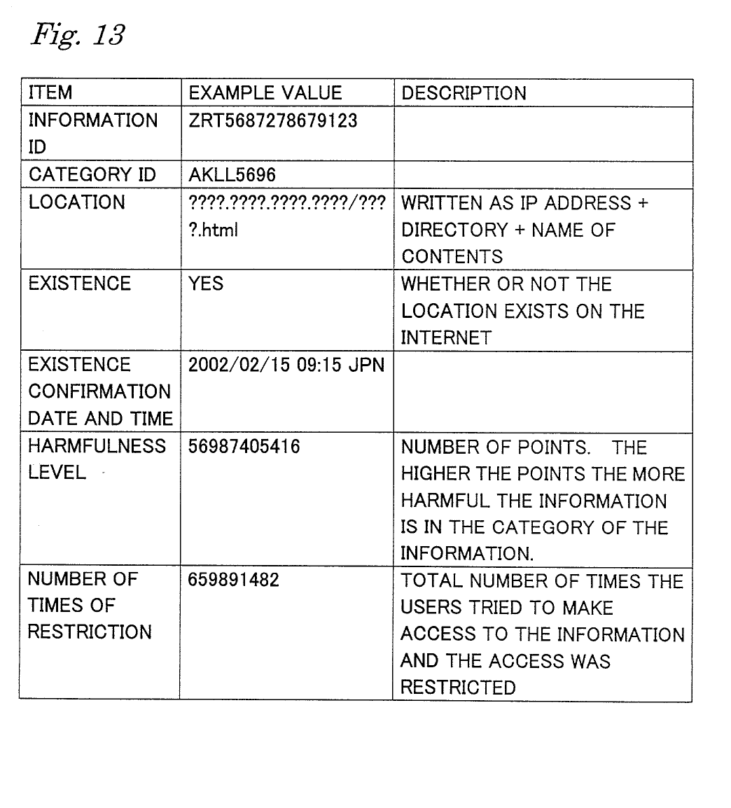

FIG. 13 shows a data structure of a harmful information list table. The table registers that harmful information from among the harmful information registered in the harmful information candidate list table of which the harmfulness level has reached the predetermined threshold value. The harmful information list table has respective fields for the information ID, the category ID, the location, the existence, the existence confirmation date and time, the harmfulness level and the number of times of restriction. The fields other than the number of times of restriction field are identical to the fields of the harmful information candidate list table.

The number of times of restriction registers a number of times that the user tried to access the harmful information and the access was restricted in accordance with the harmful information list. The user's personal computer 11 records the number of times of such restriction of access, and reports the number of times of restriction when it logs off from the present information system. The harmful information processing server 1 totals the number of times of restriction reported from the user's personal computer 11 per each item of harmful information, and records this.

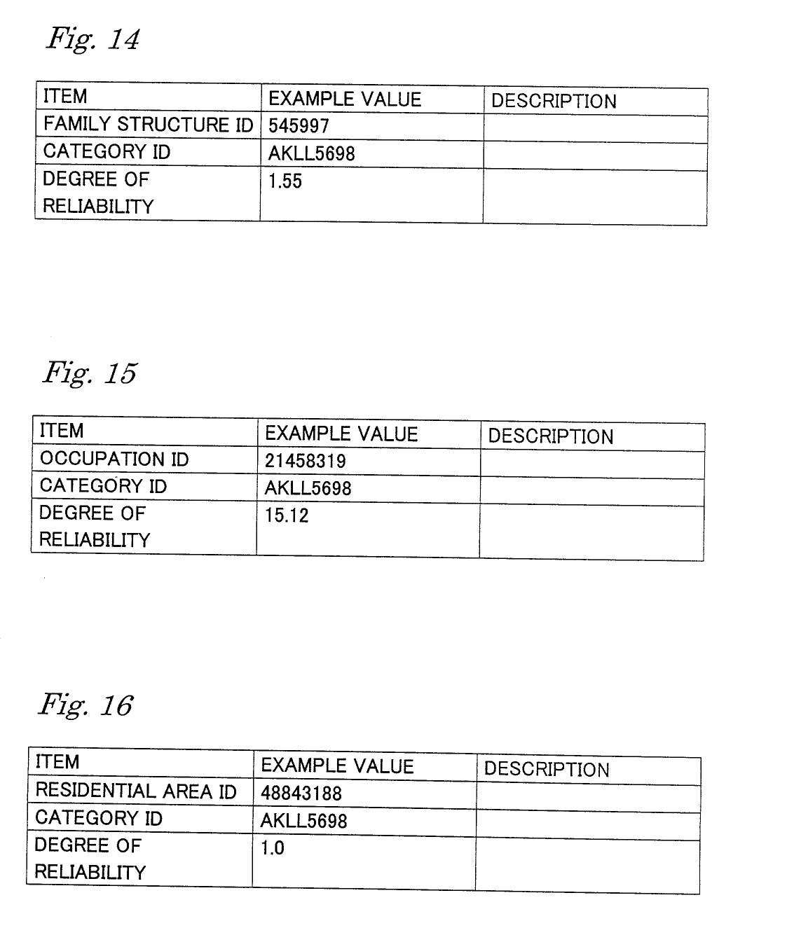

FIG. 14 shows a data construction of a table of a degree of reliability by a family structure and by a category. The table stipulates a degree of reliability with respect to a combination of the family structure and the category. The degree of reliability is a multiple parameter of a sum produced when the add-to points in the report table of FIG. 11 are added to the harmfulness level in either the harmful information candidate table of FIG. 12 or the harmful information table.

When the degree of reliability is greater than 1, the add-to points are increased and added to the harmfulness level. When the degree of reliability is less than 1, the add-to points are decreased and added to the harmfulness level. For example, the reliability of the report regarding pornography and violence by the reporter who has children is frequently set high. This degree of reliability is determined empirically by a statistical method such as correlation analysis, based on a relationship between the family structure ID and contribution points of reporters who provided previous reports, and it is updated daily.

FIG. 15 shows a data structure of a table of a degree of reliability by occupation and by a category. The table stipulates a degree of reliability with respect to a combination of the occupation of the reporter and the category. The value of the degree of reliability has the same meaning as in the case of the table of the degree of reliability by a family structure and by a category shown in FIG. 14. For example, the reliability of the report regarding pornography from the elementary or junior high school teacher is frequently set high. The table of degree of reliability by occupation and by a category is determined empirically by a statistical method such as correlation analysis, based on a relationship between the occupation ID and contribution points of reporters who provided previous reports, and it is updated daily.

FIG. 16 shows a data structure of a table of a degree of reliability by a residential area and by a category. The table stipulates a degree of reliability with respect to a combination of the residential area of the reporter and the category. The value of the degree of reliability has the same meaning as in the case of the table of the degree of reliability by a family structure and by a category shown in FIG. 14. The degree of reliability in the table of degree of reliability by a residential area and by a category is determined empirically by a statistical method such as correlation analysis, based on a relationship between the residential area ID and contribution points of reporters who provided previous reports, and it is updated daily.

<Screen Structure>

FIG. 17 shows an example of a screen displayed on the personal computer 11 of the reporter (user) by the information system. On this screen there are displayed a reporting window 12 and a normal viewing window 14 of the browser.

The reporting window 12 displays report buttons 13 with labels such as “violence”, “porno”, “anti-XX Co.” and the like. The labels of the report buttons 13 correspond to the categories registered as the category IDs in the reporter table for the reporter in question contained in the harmful information processing server 1.

That is, when the reporter first logs into the system the reporter system is downloaded. The reporter incorporates the reporter system into his or her own browser.

The browser having the incorporated reporter system displays the reporting window 12. Then, the browser requests data to display the report buttons 13 from the harmful information processing server 1. Then, the harmful information processing server 1 reads out the category ID from the user table for that user, and displays on the personal computer 11 of the reporter the report buttons 13 with corresponding labels.

The normal viewing window 14 is for viewing normal web sites, not the report buttons 13. When the user discovers harmful information while viewing the web sites with the normal viewing window 14, the user presses that button 13 in the reporting window 12 which has the label of the appropriate category. For example, when the user discovers a web site containing pornography, he or she presses the reporting button 13 with the label “porno”.

Then, the browser having the incorporated reporter system obtains the URL of the web site displayed in the normal viewing window 14, and reports this to the harmful information processing server 1. In order to do this, the URL of the web site displayed in the normal viewing window 14 may be recorded in a shared memory and made so that it can be cross-referenced between processes inside the personal computer 11 (i.e., between tasks, between threads or between modules), for example.

<Operation>

FIG. 18 shows a procedure of collecting the harmful information in the present information system. In the information system of the present embodiment, it is assumed that the user has already completed, at a given application site, an application for use in which the user's personal attributes and the like were written. This application site is a web site provided by the harmful information processing server 1. At the time of the application, the user proposes that he or she wants to use the system as the reporter. At this time a user ID and a password are given to the user.

In this system, first, the reporter logs into the harmful information processing server 1 which manages the present information system (this is described in FIG. 18 as “log into system”) (S1).

Then, the harmful information processing server 1 receives an authentic reporter login (S2). Then, based on a cookie received from the reporter's browser, the harmful information processing server 1 determines whether or not the reporter system has already been downloaded to the reporter's personal computer 11. In the case where the reporter system has not yet been downloaded, the harmful information processing server 1 provides the reporter system to the reporter's personal computer 11 (S3). This reporter system is incorporated into the browser and started on the reporter's personal computer 11 (S4).

The browser having the incorporated reporter system access the harmful information processing server 1 and requests the display of the report buttons 13. Then, the harmful information processing server 1 reads out the category IDs from the reporter table for that reporter, and displays the report buttons 13 on the reporting window 12 shown in FIG. 17.

Next, the reporter uses the normal viewing window 14 shown in FIG. 17 and accesses the Internet (S5). At this time, in the case where the web site viewed by the reporter contains harmful information (YES at S6), the reporter clicks on the report buttons 13 in the reporting window 12 (S7). Then, the reporting system works with the browser and sends to the harmful information processing server 1 the report containing the location of the web site which the browser is currently displaying in the normal viewing window 14 (S8).

Then, the harmful information processing server 1 updates the report table based on the reporter's personal information (i.e., the content of the personal information table) and the category of the information in question (i.e., the category ID determined by the type of the report button 13). Next, the harmful information processing server 1 updates either the harmful information candidate list or the harmful information list, or both, based on the report. Additionally, the harmful information processing server 1 informs the reporter that it has completely received the report (S9). At this time, the browser having the incorporated reporter system displays that the report has been completely received (SA).

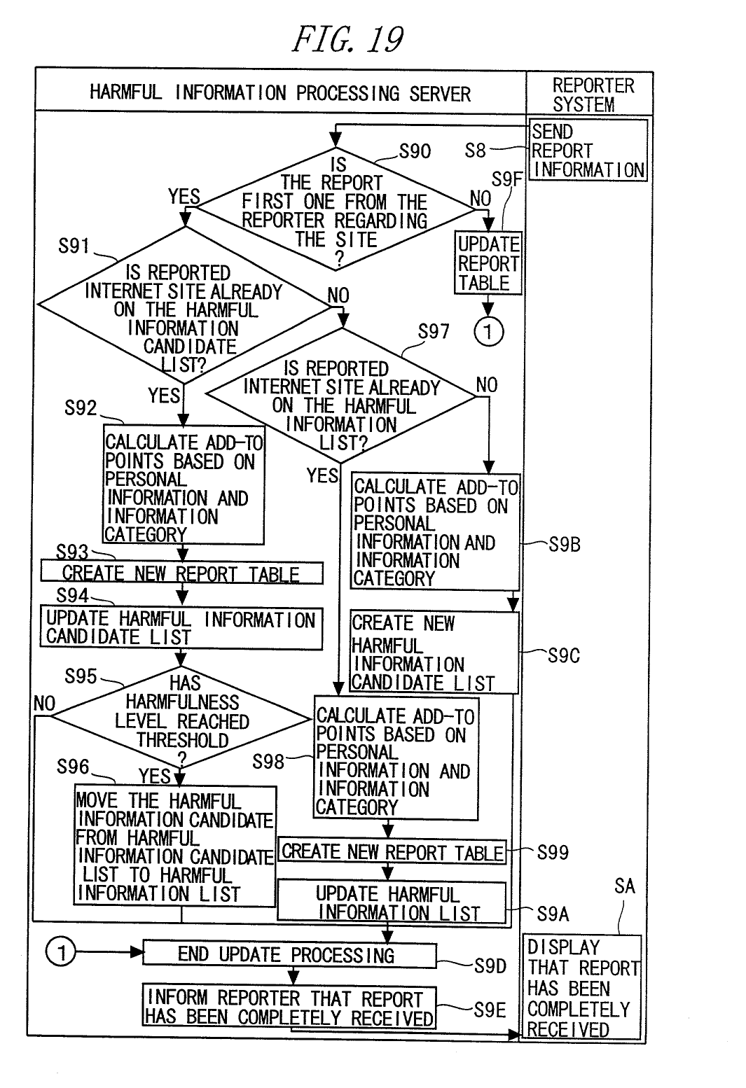

FIG. 19 shows a procedure to update (create) the harmful information list in the harmful information processing server 1. This processing is the details of the processing of S9 in FIG. 18. That is, this processing is started by the report from the reporter system (S8).

Then, the harmful information processing server 1 determines whether or not the report is the first from the reporter regarding the site (i.e., the harmful information) (S90). In the case where the report is the first, the harmful information processing server 1 determines whether the Internet site for which the report was received is already in the harmful information candidate list or not (S91).

In the case where the site already exists in the harmful information candidate list, the harmful information processing server 1 calculates the add-to points based on the reporter's personal information and the category of the information provided by the site (S92). The add-to points are derived from an empirical value based on previous reports.

The add-to points are calculated by a statistical means based on a relationship among the reporter's family structure, occupation and residential area, the information category, and the reporter's contribution points. Then, high add-to points are set for the reporter whose family structure, occupation and residential area have high contribution points.

Next, the harmful information processing server 1 creates a new report table (S93). Then, the harmful information processing server 1 updates the harmful information candidate list (S94). Next, the harmful information processing server 1 determines whether or not the harmfulness level has become equal to or greater than the threshold value (S95).

Then, in the case where the harmfulness level has become equal to or greater than the threshold value, the harmful information processing server 1 moves the site (i.e., the harmful information candidate) from the harmful information candidate list to the harmful information list (S96). After that, the harmful information processing server 1 progresses control to S9D.

On the other hand, at the determination of S91, in the case where the Internet site for which the report was received does not exist in the harmful information candidate list, the harmful information processing server 1 determines whether that site already exists in the harmful information list or not (S97).

In the case where the site exists in the harmful information list, the harmful information processing server 1 calculates the add-to points based on the reporter's personal information and the category of the information provided by the site (S98). This processing is similar to the processing of S92.

Next, the harmful information processing server 1 creates the new report table (S99). Then, the harmful information processing server 1 updates the harmful information list (S9A). After that, the harmful information processing server 1 progresses control to S9D.

Further, at the determination of S97, in the case where the site for which the report was received does not exist in the harmful information list, the harmful information processing server 1 calculates the add-to points (S9B). This processing is similar to the processing of S92. Next, the harmful information processing server 1 creates the harmful information candidate list (S9C). After that, the harmful information processing server 1 progresses control to S9D.

Further, at the determination of S90, in the case where the report is not the first from that reporter regarding that site, the harmful information processing server 1 updates the reporter's report table (i.e., the number of times of the report was made)

After that, the harmful information processing server 1 ends the update processing (S9D), and it informs the reporter's personal computer 11 that the report has been completely received (S9E). The browser having the incorporated reporter system displays that the report has been completely received (SA).

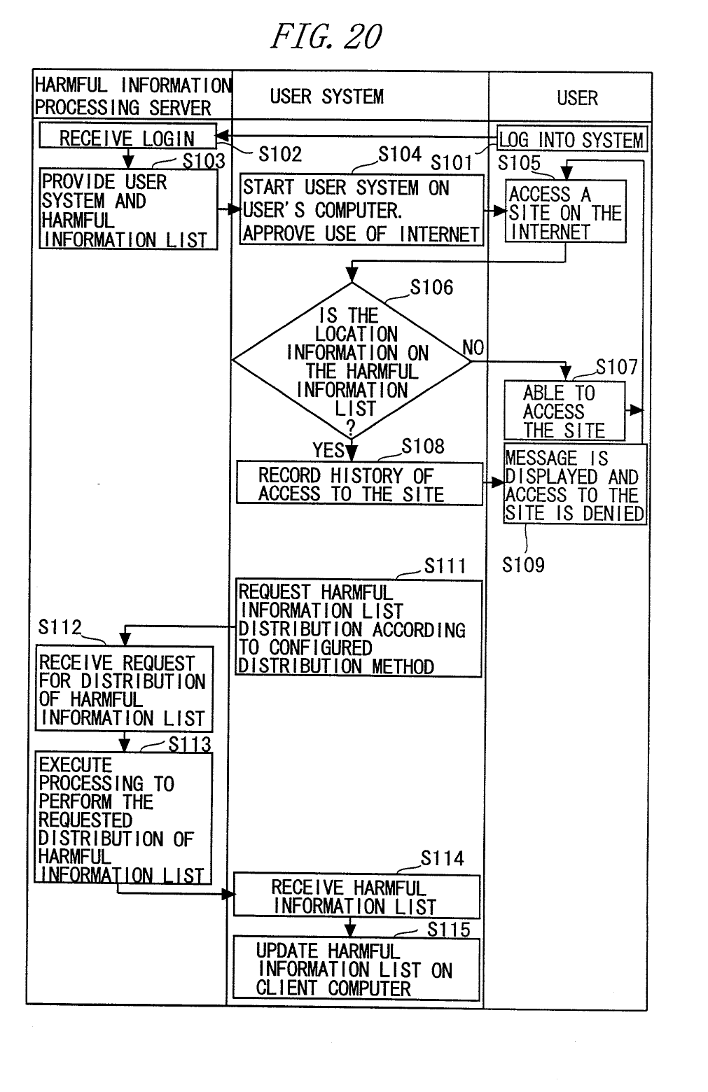

FIG. 20 shows a procedure of distributing to the user of the harmful information list and restricting access to a harmful site. According to the system, first, the user logs into the harmful information processing server 1 which manages the present information system (S101).

Then, the harmful information processing server 1 receives a login by an authorized user (S102). Then, based on a cookie received from the reporter's browser, the harmful information processing server 1 determines whether or not the user system has already been downloaded to the user's personal computer 11. In the case where the user system has not yet been downloaded, the harmful information processing server 1 provides the user system and the harmful information list to the user.

Further, in the case where the user system has already been downloaded, the harmful information processing server 1 provides the harmful information list to the user (S103). The user system is incorporated into the browser, and it is started on the user's personal computer 11 (S104).

Each time that the browser having the incorporated user system accesses a web site on the Internet, it confirms whether or not that site is included in the harmful information list, and restricts access to a site which is included in the harmful information list.

That is, the user uses the normal viewing window 14 of the browser shown in FIG. 17 and accesses the Internet (S105). Then, the user system determines whether the site is included in the harmful information list or not (S106).

Then, in the case where the site is included in the harmful information list (YES at S106), the user system records a history of access to that site (S108). Then, the browser (i.e., the user system) displays a message to the user indicating that access cannot be made to the site (S109).

On the other hand, at the determination made at S106, in the case where the site is not included in the harmful information list (NO at S106), the browser (i.e., the user system) accesses the site and displays information from the site (S107). After that, the user repeats the operation of S105.

Additionally, when a predetermined time is reached, the user system makes a request for distributing (update) of the harmful information list (S111). Then, the harmful information processing server 1 receives the request for distribution of the harmful information list (S112). Then, the harmful information processing server l distributes the most recent harmful information list (S113).

Accordingly, the user system receives the harmful information list and updates its own harmful information list (S115).

<Effects of the Embodiment>

As explained above, according to the present invention, it is possible to obtain the cooperation of the user to discover the harmful information. The discovered harmful information is reported to the harmful information processing server 1; therefore, the harmful information processing server 1 can manage the locations of the harmful information unitarily. As a result, the harmful information processing server 1 can efficiently inform the user of the locations of the harmful information site.

The user of the system no longer mistakenly accesses the information which is harmful to him or her, and is no longer disturbed. Further, educational institutions and the like can automatically execute the access restrictions on a child who is an Internet user.

Further, according to the above system, when the user (or the reporter) logs in, the cookie is used to confirm whether the user system (or the reporter system) has already been downloaded or not; and in the case where it has not been downloaded, the user system (or the reporter system) is downloaded. Accordingly, it is possible for the user to restrict access to the harmful information in a reliable fashion regardless of the device which is used for accessing the Internet. For example, it is possible to restrict the access to the harmful information in a unified fashion regardless of the device or of the site, such as a workplace, the home or a school, at which the personal computer 11 is installed.

<Variation Example>

According to the above-mentioned embodiment, the user system or the reporter system was downloaded to the user or the reporter in a format of a module to be incorporated into the browser (or a patch file for patching a specific module of the browser). However, implementation of the present invention is not restricted to this kind of procedure.

For example, it is also possible to download an entire browser which is dedicated for use with the present information system. FIG. 21 shows an example of a reporting screen 15 of this kind of dedicated browser. The reporting screen 15 is comprised of a button array on a screen left portion, and a browser from a screen center to a right portion.

In the button array of the screen left portion, there are displayed report buttons 13 having labels such as “violence”, “pornography” and “anti-XX Co.”. The function of the report buttons 13 is similar to the case of the above-mentioned embodiment.

Further, the browser from the screen center to the right portion can be operated similarly to the normal browser. As in the above-mentioned embodiment, the browser restricts the access to the sites included in the harmful information list.

<Computer Readable Recording Medium>

A program which is executed on the harmful information processing server 1 according to the above-mentioned embodiment, a program such as the user system, the reporter system, the dedicated browser shown in FIG. 21 and the like can be recorded onto a computer readable recording medium. Then, by making the computer read and execute the program in the recording medium, it becomes possible to make the computer function as a constitutive element of the information system shown in the above-mentioned embodiment.

Here, the computer readable recording medium refers to a recording medium which can store information such as data or a program by means of electric, magnetic, optical, mechanical or chemical operation, and can be read from the computer. Among such recording media, examples of media which are removable from the computer include a floppy disk, an optical magnetic disk, a CD-ROM, a CD-R/W, a DVD, a DAT, an 8 mm tape, a memory card and the like.

Further, examples of recording media which are fixed to the computer include a hard disk, a ROM (Read Only Memory) and the like.

<Data Communication Signal Embodied in Carrier Waves>

Further, it is possible to store the above-mentioned program in a hard disk or a memory of the computer, and distribute it to another computer through a communication medium. In this case, the program is transmitted through the communication medium as a data communication signal which has been embodied by carrier waves. Then, it is possible to make the computer which has received the distribution function as a constitutive element of the information system of the above-mentioned embodiment.

Here, the communication medium may be either wired communications media, including metal cables such as a coaxial cable or a twist pair cable, an optical communications cable or the like; or wireless communications media, such as satellite communications, ground wave wireless communications or the like.

Further, the carrier waves are electromagnetic waves or light for modulating the data communications signal. However, the carrier waves may also be a direct current signal. In this case, the data communications signal has a wave form of a baseband without carrier waves. Therefore, the data communications signal embodied in the carrier waves may be either a modulated broad band signal, or an unmodulated baseband signal (equivalent to a direct current signal having a voltage of 0 being used as the carrier waves).

What is claimed is:

1. An information evaluation system for evaluating information to be viewed on a network, the system comprising:
receiving unit receiving a report on information which is inappropriate for viewing;
evaluating unit evaluating an inappropriateness level of the information based on the report; and
distributing unit distributing information regarding locations on the network of such inappropriate information having the inappropriateness level in a predetermined range.

2. An information evaluation system according to claim 1, further comprising classifying unit classifying a reporter who sent the report into a classification; wherein
the evaluating unit evaluates the inappropriateness level of the information in accordance with the classification of the reporter.

3. An information evaluation system according to claim 1, further comprising identifying unit identifying a reporter who sent the report; wherein
the report includes the information regarding the location of the information on the network; and
the evaluating unit excludes a second report and subsequent reports by the same reporter regarding the same location from its evaluation of the inappropriateness level.

4. An information evaluation system according to claim 1, further comprising:
identifying unit identifying a reporter who sent the report; and
accumulating unit accumulating information pertaining to contributions per reporter in the evaluation of the inappropriateness level; wherein
the evaluating unit reflects the contributions accumulated per reporter in its evaluation of the inappropriateness level of the information.

5. An information evaluation system according to claim 1, wherein
the report has a category of information which is a subject of the report; and
the evaluating unit evaluates the inappropriateness level of the information per the category.

6. An information evaluation system according to claim 1, further comprising:
identifying unit identifying a reporter who sent the report;
classifying unit classifying the reporter into a classification; and
accumulating unit accumulating information pertaining to contributions per reporter in the evaluation of the inappropriateness level; wherein
the report has a category of the information which is the subject of the report; and
the evaluating unit reflects a relationship of a combination of 2 or more from among the category, the classification of the reporter and the contributions accumulated per reporter in its evaluation of the inappropriateness level.

7. A terminal comprising:
accessing unit accessing information on a network;
displaying unit displaying the information;
inputting unit inputting a report on the display of information which is inappropriate for viewing;
sending unit sending the report to a predetermined server;
receiving unit receiving, from the server which has totaled up the reports, locations on the network of such inappropriate information having an inappropriateness level in a predetermined range; and
restricting unit restricting access to the inappropriate information.

8. A computer readable recording medium having recorded thereon a program for making a computer evaluate information to be viewed on a network, the program comprising the steps of:
receiving a report on information which is inappropriate for viewing;
evaluating an inappropriateness level of the information based on the report; and
distributing information regarding locations on a network of such inappropriate information having the inappropriateness level in a predetermined range.

9. A computer readable recording medium having recorded thereon a program according to claim 8, the program further comprising the steps of:
identifying a reporter who sent the report;
classifying the reporter into a classification; and
accumulating information pertaining to contributions per reporter in the evaluation of the inappropriateness level; wherein
the report has a category of the information which is the subject of the report; and
a relationship of a combination of 2 or more from among the category, the classification of the reporter and the contributions accumulated per reporter in its evaluation of the inappropriateness level is reflected in the evaluating step.

10. A computer readable recording medium having recorded thereon a program making a computer execute the steps of:
accessing information on a network;
displaying the information;
inputting a report on the display of information which is inappropriate for viewing;
sending the report to a predetermined server;
receiving, from the server which has totaled up the reports, locations on the network of such inappropriate information having the inappropriateness level in a predetermined range; and
restricting access to the inappropriate information.
